(19) United States
(12) Patent Application Publication
(10) Pub. No.: US 2007/0144183 A1
(43) Pub. Date: Jun. 28, 2007

(54) Liquid fuel storage system

(75) Inventor: Yuichi Sakajo, Toyohashi-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/605,964

(22) Filed: Nov. 30, 2006

(30) Foreign Application Priority Data
Dec. 22, 2005 (JP) 2005-369227

(51) Int. Cl. F25B 19/00; B60H 1/32; F25J 1/00

(52) U.S. Cl. 62/7; 62/239; 62/615

(57) ABSTRACT

A liquid fuel storage system to be mounted on an electric motorcar has a first storage container for storing liquid fuel such as liquid hydrogen, one or more heat exchangers performing heat exchange between air and the liquid fuel or fuel gas vaporized from the liquid fuel, a second storage container, and a low temperature air supply line. The second storage container surrounds the outer periphery of the first storage container and stores the liquid air obtained by the heat exchange. An air conditioning system and/or a cold container that are mounted on the electric motorcar use the air supplied through the low temperature air supply line.

### CROSS-REFERENCE TO RELATED APPLICATION

This application is related to and claims priority from Japanese Patent Application No. 2005-369227 filed on Dec. 22, 2005, the contents of which are hereby incorporated by reference.

### BACKGROUND OF THE INVENTION

1. Field of the Invention

The present invention relates to a liquid fuel storage system, equipped with a liquid fuel storage container configured to store liquid fuel such as liquid hydrogen, to be mounted on movable bodies, in particular, mounted on electric motorcars equipped with a fuel cell stack.

2. Description of the Related Art

One of important problems to be solved involved in the technical field of electric motorcars equipped with a fuel cell stack as electric power source is to increase a mileage of an electric motorcar per fuel charge. In order to increase the mileage of an electric motorcar per fuel charge, there are conventional techniques. One technique increases the efficiency of electric power generation of a fuel cell system, and another technique increases the storage amount of liquid hydrogen as fuel. However, in the view of a limited space of the electric motorcar for mounting a fuel storage container and other components, it is difficult to mount a large-sized fuel storage container. The fuel storage container mounted on the electric motorcar is therefore requested to increase the filling density of fuel material such as liquid hydrogen. Today, a high-pressure hydrogen gas tank or a liquid hydrogen storage container is mounted on an electric motorcar that is equipped with a fuel cell stack. Such a high-pressure hydrogen gas tank contains approximately 35 Mega pascal (MPa) or 70 MPa high-pressure hydrogen gas. Because the liquid hydrogen storage container has a superior feature to contain a higher filling-density of hydrogen rather than that of the high-pressure hydrogen gas tank, it is necessary to cool liquid hydrogen at approximately minus 253° C. (−253° C.). For this reason, the increase of invasion of external thermal energy into the inside of the liquid hydrogen tank vaporizes a part of the liquid hydrogen. Because this vaporization phenomenon increases the inside pressure of the liquid hydrogen tank, it is necessary to discharge the hydrogen gas (boil off gas (BOF)) generated by the vaporization to the outside of the liquid hydrogen tank.

There is another conventional technique of reducing the amount of BOF in the liquid hydrogen tank by storing liquid air around liquid hydrogen stored in the liquid hydrogen tank. For example, Published Japanese translation JP 2004-512482 of a PCT application (International application No. PCT/EP2001/012057, International laid open published No. WO 2002/035143 has disclosed such a conventional technique. However, the technique JP 2004-512482 uses the liquid air only for preventing the generation of BOF (boil-off gas) of the liquid hydrogen. In other words, liquid air is not better used for various applications, only used for suppressing the generation of BOF of liquid hydrogen. That is, such a conventional drawback is involved in various applications which use liquid air for cooling various low temperature liquid materials in addition to liquid hydrogen.

### SUMMARY OF THE INVENTION

The present invention has been made in consideration of such views of the related art described above. An object of the present invention is to provide a liquid fuel storage system configured to store low temperature liquid fuel such as liquid hydrogen efficiently using thermal energy (or refrigeration energy) of liquid air.

According to an aspect of the present invention, there is provided a liquid fuel storage system having a first storage container, a heat exchanger, a second storage container, and a low temperature air supply line. The first storage container is configured to store a liquid fuel. The heat exchanger is configured to perform heat exchange between air and liquid fuel or fuel gas vaporized from the liquid fuel and air. The second storage container surrounds an outer periphery of the first storage container and is configured to store liquid air obtained by the heat exchange performed by the heat exchanger. Through the low temperature air supply line, the air is fed from the second storage container, and supplied to an outside of the liquid fuel storage system for use. In particular, the low temperature air supply line is joined to an air conditioning apparatus mounted on a vehicle. The air is fed and then supplied to the air conditioning apparatus through the low temperature air supply line. The air conditioning apparatus performs air conditioning of a compartment of the vehicle using the supplied air. Thus, the liquid air stored in the second storage container which surrounds the outer periphery of the first storage container can be used for another purpose other than preventing the invasion of thermal energy into the liquid fuel stored in the first storage container. This can achieve the better use of the cooling capability of the liquid air.

According to another aspect of the present invention, there is provided the liquid fuel storage system further having an air supply adjusting valve and a control means. The air supply adjusting valve is configured to open and close the low temperature air supply line. The control means is configured to control operation of the air supply adjusting valve. It is thereby possible to optionally adjust the supply amount of the low temperature of the air to be fed to the outside through the low temperature air supply line.

Further, according to another aspect of the present invention, there is provided the liquid fuel storage system further having a liquid air storage amount detecting means that is configured to detect an amount of the liquid air stored in the second storage container. In the system, the control means opens the air supply open/close valve when a judging result thereof indicates that the amount of the liquid air stored in the second storage container is an adequate amount for preventing vaporization of the liquid fuel stored in the first storage container. The control means closes the air supply open/close valve when the judging result thereof indicates that the amount of the liquid air stored in the second storage container does not reach the adequate amount to prevent vaporization of the liquid fuel stored in the first storage container. It is thereby possible to maintain the amount of the liquid air that is the minimum value necessary to prevent the vaporization of the liquid fuel, and to perform the effectively better use of the liquid air while preventing any vaporization of the liquid fuel by preventing any invasion of the external thermal energy into the liquid fuel stored in the first storage container.

Still further, according to another aspect of the present invention, there is provided the liquid fuel storage system in which the liquid air storage amount detecting means is a liquid surface level sensor.

Still further, according to another aspect of the present invention, there is provided the liquid fuel storage system further having an air supply pump that is configured to supply the liquid air exhausted from the second storage container to the low temperature air supply line. In the system, the control means operates the air supply pump and opens the air supply adjusting valve simultaneously. It is thereby possible to supply certainly the low temperature air to the outside through the low temperature air supply line.

Moreover, according to another aspect of the present invention, there is provided the liquid fuel storage system in which it is so constructed that the air supplied from the second storage container through the low temperature air supply line is directly introduced into a compartment of a vehicle on which the liquid fuel storage system is mounted.

Moreover, according to another aspect of the present invention, there is provided the liquid fuel storage system in which the control means controls the supply amount of the liquid air from the second storage container according to magnitude of a requested load for the air conditioning of a compartment of a vehicle. Because the air conditioning capability of the compartment of the electric motorcar can be adjusted only by changing the supply amount of the liquid air, it is possible to easily control the air conditioning capability of the air conditioning apparatus mounted on the electric motorcar.

Still moreover, according to another aspect of the present invention, there is provided the liquid fuel storage system in which it is so constructed that the air fed to the outside from the second storage container through the low temperature air supply line is supplied into a cold container, which is mounted on a vehicle on which the liquid fuel storage system is mounted, in order to cool contents placed in a cold room in the cold container. This configuration can be effectively utilized for cooling the cold container.

Further, according to another aspect of the present invention, there is provided the liquid fuel storage system in which the cold container having a temperature sensor configured to detect an inside temperature of the cold room and the control means controls the supply amount of the liquid air from the second storage container through the low temperature air supply line based on the inside temperature of the cold room in the cold container detected by the temperature sensor. The cooling capability of the cold container mounted on the electric motorcar can be adjusted only by changing the supply amount of the liquid air.

Still further, according to another aspect of the present invention, there is provided the liquid fuel storage system in which the liquid fuel is liquid hydrogen as a fuel of a fuel cell stack mounted on a vehicle as driving power source. Because this configuration enables to use the liquid air, (although, the original purpose of the use of the liquid air is to prevent the vaporization of the liquid hydrogen stored in the first container), used for cooling the inside of the compartment of the electric motorcar or the cold container mounted on the electric motorcar, it is possible to decrease the load of the air conditioning apparatus and the load of the cold container which use a thermal cycle.

### BRIEF DESCRIPTION OF THE DRAWINGS

For a better understanding of the present invention and to show how the same may be carried out into effect, there will now be described by way of example only, specific embodiments and methods according to the present invention with reference to the according to the present invention.

FIG. 1 is a schematic view of a liquid fuel storage system according to a first embodiment of the present invention;

FIG. 2 is a flow chart showing an air conditioning step for a compartment in an electric motorcar equipped with the liquid fuel storage system according to the first embodiment shown in FIG. 1; and

FIG. 3 is a sectional view of a cold container to be mounted on the liquid fuel storage system according to a second embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several views.

### First Embodiment

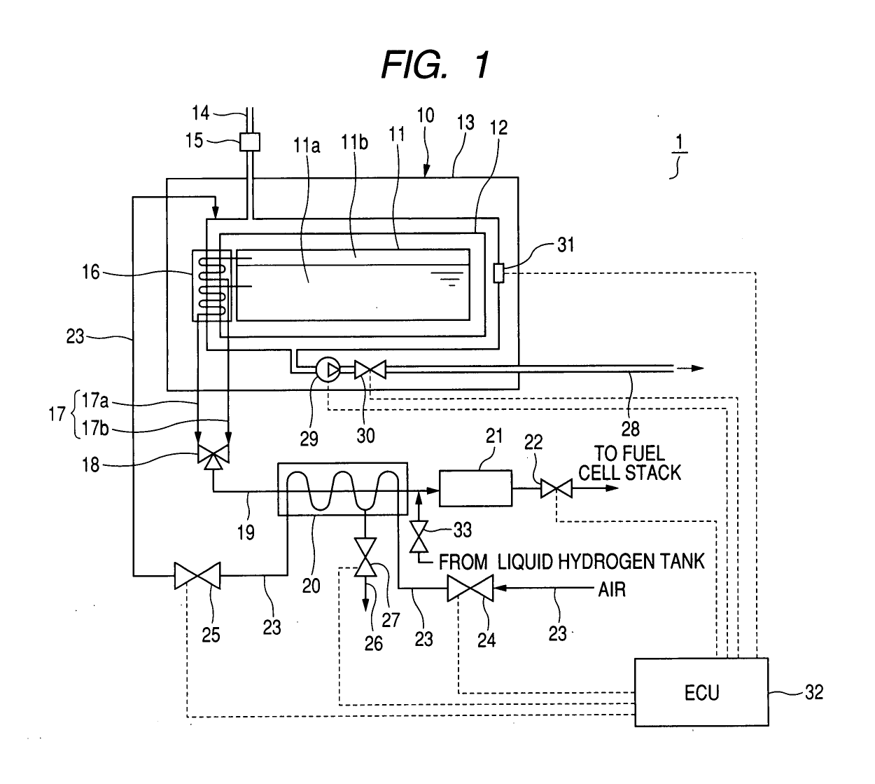

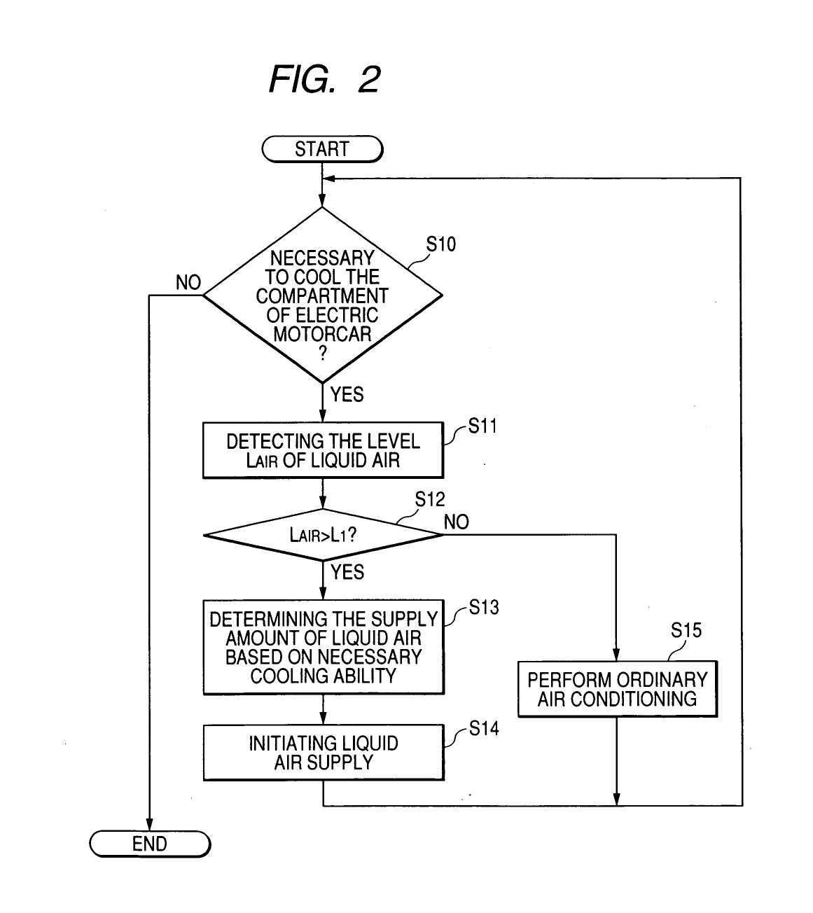

A description will be given of a liquid fuel storage system 1 equipped with a liquid hydrogen storage container according to the first embodiment with reference to FIG. 1 and FIG. 2.

In the first embodiment, the concept of the present invention is applied to the liquid fuel storage system 1 equipped with the liquid hydrogen storage container 10 configured to store liquid hydrogen to be supplied to a fuel of a fuel cell stack (omitted from the drawings). Such a liquid hydrogen storage container 10 is to be mounted on vehicles such as an electric motorcar (a fuel cell vehicle) using the fuel cell stack as an electric power source. The electric motorcar is equipped with an air conditioning apparatus for air conditioning of the inside of a compartment of the electric motorcar. The air conditioning apparatus performs a well-known thermal cycle system composed of a vaporizer, a compressor, a condenser, a pressure reduction means, and the like.

FIG. 1 is a schematic view of the liquid fuel storage system 1 equipped with the liquid hydrogen storage container 10 according to the first embodiment of the present invention. As shown in FIG. 1, the liquid hydrogen storage container 10 has a multiple layer configuration that consists of a first storage container 11, a second storage container 12, and a thermal insulation part 13. The first storage container 11 is a liquid hydrogen storage container located at the most inside of the liquid hydrogen storage container 10. The second storage container 12 is a liquid air storage container that covers the outer periphery of the first storage container 11. The thermal insulation part 13 is composed of heat insulating material.

The space between the first storage container 11 and the second storage container 12 is in vacuum. Liquid hydrogen 11a is stored in the bottom part of the first storage container 11. Hydrogen gas 11b vaporized is in the upper part of the first storage container 11 when a part of liquid hydrogen 11a is evaporated.

In the liquid hydrogen storage container 10, the second storage container 12 and the thermal insulation part 13 are formed in multiple layer configuration at the outer periphery of the first storage container 11. The configuration of the liquid hydrogen storage container 10 shown in FIG. 1 can prevent the invasion of external heat into the first storage container 11 and also prevent the evaporation of the liquid hydrogen 11a inside of the first storage container 11.

As shown in FIG. 1, an air gas exhaust line 14 is jointed to the second storage container 12 so as to exhaust the air gas therein when the liquid air is evaporated in the second storage container 12. The air gas exhaust line 14 is a communication line through which the upper inside part of the second storage container 12 is connected to the outside of the second storage container 12. A relief valve 15 is mounted on the air gas exhaust line 14. This relief valve 15 closes in mechanism the air gas exhaust line 14 during the normal condition of the liquid gas storage system 1.

When an inside pressure of the second storage container 12 exceeds a specified value determined in advance, the relief valve 15 is opened so as to prevent the pressure rise of the second storage container 12.

The second storage container 12 is equipped with a first heat exchanger 16. A liquid hydrogen introduction/exhaust line 17a and a hydrogen gas exhaust line 17b pass through the inside of the first heat exchanger 16. Through the liquid hydrogen introduction/exhaust pile 17a, the liquid hydrogen 11a is taken out from the first storage container 11 in the liquid hydrogen storage container 10, and liquid hydrogen is on the contrary supplied from an outside container (omitted from the drawings) into the first storage container 11. Further, the liquid hydrogen 11a is vaporized and the vaporized hydrogen gas 11b is taken out from the first storage container 11 through the hydrogen gas exhaust line 17b. The first heat exchanger 16 performs heat exchange between air in the second storage container 12 and hydrogen passing through the liquid hydrogen introduction/exhaust line 17 and the hydrogen gas exhaust line 17b.

As shown in FIG. 1, both the liquid hydrogen introduction/exhaust line 17a and the liquid hydrogen exhaust line 17b are joined to a hydrogen common line 19 through a three way valve 18.

On the way of the hydrogen common line 19, a second heat exchanger 20, a third heat exchanger 21, and a hydrogen shut-off valve 22 are mounted. A temperature of hydrogen passing through the hydrogen common line 19 rises by both of the second heat exchanger 20 and the third heat exchanger 21. The heat exchanging mechanism of the second heat exchanger 20 will be detailed later.

The third heat exchanger 21 is so constructed that through the third heat exchanger 21, a cooling water for cooling a fuel cell stack (omitted from the drawings) passes, where heat exchange is performed between the cooling water for the fuel cell stack and the hydrogen passing through the hydrogen common line 19.

The first heat exchanger 16, the second heat exchanger 20, and the third heat exchanger 21 increase in order the temperature of hydrogen flowing through the hydrogen common line 19, and the cooled hydrogen is then supplied as a fuel to the outside, namely, to the fuel cell stack (omitted from the drawings).

The supply amount of hydrogen is controlled by opening/closing or by adjusting the opening ratio of the hydrogen open/close valve (the hydrogen shut-off valve) 22. The fuel cell stack (not shown) carries out electric power generation by chemical reaction between hydrogen and oxygen.

Liquid hydrogen is supplied from a liquid hydrogen tank (not shown) to the inside of the first storage container 11 by opening a hydrogen opening/closing valve 33 through the second heat exchanger 20 and the first heat exchanger 16. Through the second heat exchanger 20 and the first heat exchanger 16, the liquid hydrogen cools air supplied from the outside through an air introduction line 23. The cooled air is supplied into the second storage container 12 through the air introduction line 23.

The second storage container 12 is joined to the air introduction line 23 through which the air is introduced from the outside. On the way to the air introduction line 23, a first air inlet open/close valve 24, a second air inlet open/close valve 25 are mounted. It is so formed that a part of the air introduction line 23 is arranged in the second heat exchanger 20, the first air inlet open/close valve 24 is placed at the upper stream side observed from the location of the second heat exchanger 20 (which is far away from the second storage container 12), and the second air inlet open/close valve 25 is placed at the down stream side observed from the location of the second heat exchanger 20 (which is near the second storage container 12).

A condensed liquid exhaust line 26 is joined to a part of the air introduction line 23 placed in the second heat exchanger 20. The outlet of the condensed liquid exhaust line 26 is joined to the outside. A condensed liquid open/close valve 27 is mounted on the way of the condensed liquid exhaust line 26.

The second heat exchanger 20 performs the heat exchange between hydrogen passing through the hydrogen common line 19 and the air passing through the air introduction line 23. The hydrogen cools the air passing through the air introduction line 23, so that moisture and carbon dioxide contained in the air passing through the air introduction line 23 are condensed out and liquid air is then generated. The generated liquid air in the air introduction line 23 is exhausted to the outside through the condensed liquid exhaust line 26 by opening the condensed liquid open/close valve 27. Thereby, the air flowing through the downstream side (which is the location near the second storage container 12) of the second heat exchanger 20 is mainly composed of nitrogen and oxygen.

The air flowing through the air introduction line 23 is forcedly cooled by the second heat exchanger 20 and then introduced into the inside of the second storage container 12, and forcedly cooled by the liquid hydrogen or hydrogen gas flowing in the first heat exchanger 16. The hydrogen flowing through the first heat exchanger 16 is lower in temperature than the hydrogen flowing through the second heat exchanger 20, and because the boiling point of hydrogen is lower than that of air that is mainly composed of nitrogen and oxygen, the air introduced in the second storage container 12 becomes liquefied.

The second storage container 12 is joined to a low temperature air supply line 28 through which the air in the second storage container 12 is supplied or exhausted to the outside. The low temperature air supply line 28 is joined to the bottom part of the second storage container 12. An air supply pump 29 and an air supply adjusting valve 30 are mounted on the way of the low temperature air supply line 28. The air supply pump 29 forcedly supplies the liquid air to the outside. The air supply adjusting valve 30 controls the opening/closing operation or an opening ratio of the low temperature air supply line 28.

Both the air supply pump 29 and the air supply adjusting valve 30 are placed in the thermal insulation part 13 composed of heat insulating material. This configuration of the air supply pump 29, the air supply adjusting valve 30 and the thermal insulation part 13 can prevent the invasion of outside thermal energy into the second storage container 12 through the air supply pump 29 and the air supply adjusting valve 30.

When the air supply adjusting valve 30 opens and the air supply pump 29 operates, the liquid air contained in the second storage container 12 is supplied or exhausted through the low temperature air supply line 28 to the outside. Because the low temperature air supply line 28 is joined to the bottom side of the second storage container 12, the liquid air smoothly flows out under its own weight from the second storage container 12 into the low temperature air supply line 28.

The liquid air supplied from the second storage container 12 absorbs the heat from the low temperature air supply line 28 and is thereby vaporized during flowing through the low temperature air supply line 28. The vaporized air is supplied as air gas to a compartment of an electric motorcar on which the liquid fuel storage system 1 of the first embodiment is mounted. The air gas is forcedly supplied to the inside of the compartment of the electric motor car by the pressure generated by vapor expansion of the liquid air. It is therefore not necessary to install any blowing means such as a blowing fun. The air flowing through the low temperature air supply line 28 is forcedly supplied directly into the inside of the compartment as a cooling air which cools the inside of the compartment. Thus, because the cooling air can be supplied into the compartment through the low temperature air supply line 28, it is not necessary to mount onto the electric motorcar a heat exchanger for use in air conditioning of the compartment. Although it is preferred that the low temperature air supply line 28 has a heat insulating mechanism, it is not necessary to have the heat insulating mechanism on the way of the low temperature air supply line 28 placed in the compartment so as to directly cool the inside of the compartment by the low temperature air supply line 28.

It is preferred to supply the air obtained through the low temperature air supply line 28 into a desired part in the compartment. For example, the low temperature air supply line 28 is so arranged or placed that the cooling air is directly supplied to the front face of a driver of the electric motor car. As described above, it is possible to realize and obtain improved and superior air conditioning efficiency by directly supplying the cooling air to a desired part in the compartment of the electric motorcar. Further, because the cooling capability for the compartment of the electric motorcar is changed by adjusting the supply amount of the cooling air, it is possible to easily control the cooling capability of the compartment of the electric motorcar.

The second storage container 12 is equipped with a liquid surface level sensor 31 that detects a surface level of the liquid air in the second storage container 12. It is possible to use a surface level sensor of an electrostatic capacity type or a float type as the liquid surface level sensor 31. The liquid surface level sensor 31 corresponds to a liquid air storage amount detecting means defined in claims of the present invention.

The liquid fuel storage system 1 of the embodiment has the hydrogen storage container 10 and an electric control unit 32 (or an electronic control unit, ECU) for performing the control to various electronic devices and the like mounted on the electric motorcar. The electric control unit (ECU) 32 is composed of a well known microcomputer comprising a central processing unit (CPU), a read only memory (ROM), a random access memory (RAM), an input/output (I/O) interface, and the like. The electric control unit (ECU) 32 executes programs stored in the ROM and others so as to carry out various calculations. The electric control unit (ECU) 32 receives various signals regarding a request signal to initiate air conditioning operation transferred from an air conditioning ECU (omitted from the drawings), and detection signals regarding the liquid surface detected by the liquid surface level sensor 31. The electric control unit (ECU) 32 is configured to generate and transfer control signals to the hydrogen shut-off valve 22, the first air inlet open/close valve 24, the second air inlet open/close valve 25, the condensed liquid open/close valve 27, the air supply pump 29, the air supply adjusting valve 30, and the like.

Next, a description will now be given of the operation of the liquid fuel storage system 1 of the first embodiment according to the present invention with reference to FIG. 2.

FIG. 2 is a flow chart showing an air conditioning manner for the compartment in the electric motorcar using the liquid fuel storage system 1 according to the first embodiment.

Firstly, at Step S10, the ECU 32 judges whether or not there is a necessity of performing the air conditioning for the compartment of the electric motor car based on the cooling request signal transferred from the air conditioning ECU (not shown).

When the judging result indicates not necessary to perform the air conditioning for the compartment, the ECU 32 terminates the air conditioning control process.

On the contrary, when the judging result indicates the necessity of carrying out the air conditioning for the compartment, the ECU 32 receives the detection signal of the liquid surface level in the second storage container 12 transferred from the liquid surface level sensor 31 (Step S11). The detection signal of the liquid surface level indicates the level L_{AIR} of the liquid air in the second storage container 12.

Next, the ECU 32 judges whether the liquid surface level L_{AIR} of the liquid air in the second storage container 12 exceeds a reference level L1 that is specified in advance (Step S12). This reference level L1 is the reference value to be used for judging whether or not the liquid air in the second storage container 12 can be used for another purpose other than the original purpose of preventing the invasion of outside thermal energy into the first container 11.

The reference level L1 of the liquid air level in the second storage container 12 can be also set as the storage amount of the liquid air that is the minimum amount of the liquid air for preventing the invasion of thermal energy from the outside and for preventing any vaporization of the liquid hydrogen 11a in the first storage container 11.

If there is a possibility of increasing the amount of hydrogen to be supplied to the fuel cell stack (not shown) during driving of the electric motorcar, because it is predicted to increase the amount of producing the liquid air by heat exchange to the low temperature hydrogen, it is possible to set the reference level L1 to a lower value for expanding the application range of the liquid air.

When the judgment result indicates that the liquid surface level L_{AIR} exceeds the reference level L1 (“YES” in Step S12), the ECU decides that the liquid air in the second storage container 12 can be used for cooling the compartment in the electric motorcar. The ECU 32 calculates the necessary cooling capability based on the cooling request signal transferred from the air conditioning ECU (not shown), and then determines the supply amount (cc/m) of the liquid air (Step S13).

If the necessary cooling capability is relatively low, the ECU 32 so controls that the supply amount of the liquid air is decreased. On the contrary, when it is high, the ECU 32 so controls that the supply amount of the liquid air is increased.

The ECU 32 controls the operation of both the air supply pump 29 and the air supply adjusting valve 30 based on the supply amount determined in Step S13. In a concrete example, the ECU 32 instructs to open the air supply adjusting valve 30 in order to operate the air supply pump 29.

When the judgment result in Step S12 indicates that the liquid surface level L_{AIR} of the liquid air in the second storage container 12 does not exceed the reference level L1 (“NO” in Step S12), the ECU 32 decides that the liquid air in the second storage container 12 cannot be used for the air conditioning, namely, cannot be used for cooling the compartment of the electric motorcar. The ECU 32 instructs the air conditioning apparatus (not shown) performing the usual cooling operation, namely, a refrigerating (or refrigeration) cycle so as to cool the inside of the compartment (Step S15).

Next, the operation flow is returned to Step S10, the repetition cycle from Step S10 to S15 is repeated until the judgment result indicates no necessity of cooling the inside of the compartment of the electric motorcar.

As described above, according to the first embodiment of the present invention, the liquid air stored in the second storage container 12 can be used for performing the air conditioning for the inside of the compartment of the electric motorcar in addition to the original purpose of preventing the invasion of outside thermal energy into the first storage container 11. It is possible to allow the liquid air contained in the second storage container 12 to better use. It is thereby possible to reduce the electric power consumption by a compressor (not shown) mounted on the air conditioner apparatus (not shown) using air conditioning cycle and as a result to reduce the entire energy consumption of an electric system (not shown) mounted on the electric motorcar.

For example, when the electric motorcar is left outside during a hot season such as summer, the driver has a strong request to rapidly decrease the room temperature of the compartment of the electric motorcar. If the room temperature is reduced only by the air conditioning apparatus mounted on the electric motorcar, it is necessary to incorporate a high performance compressor for the air conditioning system in the electric motorcar. According to the embodiment of the present invention, because the liquid air can be used in such a case of rapidly cooling the room temperature of the compartment (cooling down of the room temperature), it is possible to mount a low performance compressor on the air conditioning system and to increase the mounting space and to reduce the manufacturing cost, and thereby to reduce the entire energy consumption of the electric motorcar.

Further, the liquid surface level sensor 31 detects the amount of the liquid air contained in the second storage container 12, and the ECU 32 so controls the liquid fuel storage system 1 in order to maintain at least the minimum amount of the liquid air in the second storage container 12 which is necessary to prevent the vaporization of the liquid hydrogen in the first storage container 11. This can prevent any vaporization of the liquid hydrogen 11a stored in the first storage container 11 and provide the effective use of the liquid air in the second storage container 12.

In addition, because hydrogen gas is continuously supplied as a fuel to the fuel cell stack (not shown) during traveling of the electric motorcar, the liquid air can be produced continuously by the heat exchanging between air and low temperature hydrogen, namely, the liquid hydrogen. If the total amount of the liquid air in the second storage container 12 is increased, an excess liquid air can be exhausted to the outside in order to prevent the occurrence of overflow of the excess liquid air from the second storage container 12.

### Second Embodiment

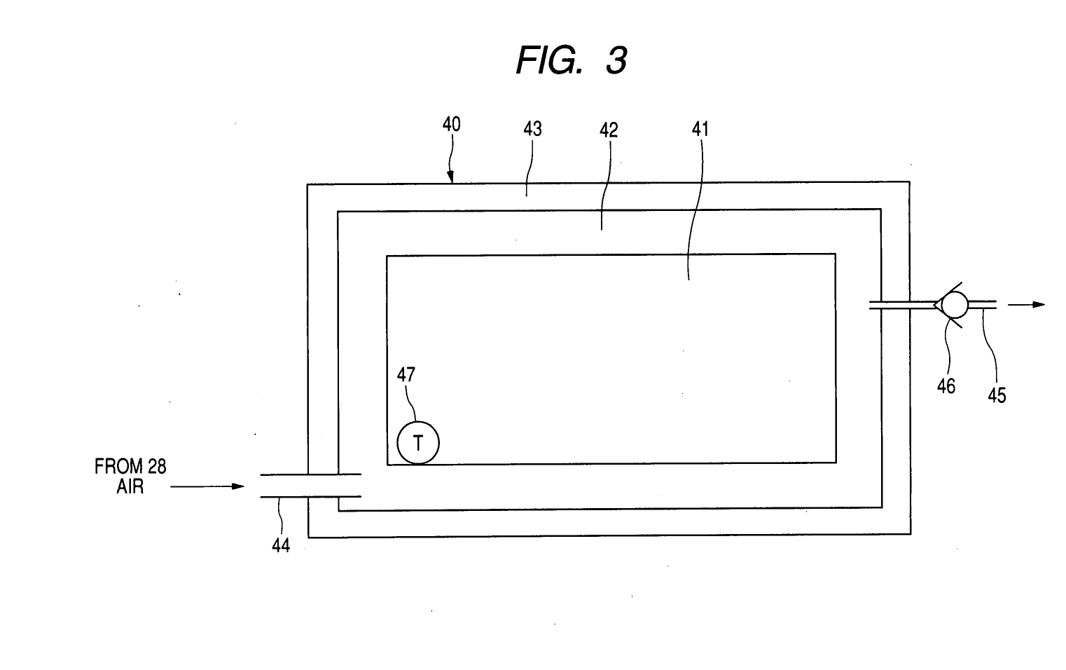

A description will be given of a liquid fuel storage system according to the second embodiment with reference to FIG. 3.

FIG. 3 is a sectional view of a cold container 40 to be mounted on the liquid fuel storage system according to the second embodiment. In particular, FIG. 3 shows only the cold container 40 because other components of the liquid fuel storage system are the same of those of the liquid fuel storage system 1 according to the first embodiment shown in FIG. 1. The explanation of the same components is omitted here.

The cold container 40 shown in FIG. 3 is capable of maintaining the temperature of a cold room 41 of the cold container 40 for storing materials at a low temperature. The cold container 40 has a multiple-layer construction. Materials such as drinking water are contained in the cold room 41 located at the most inner layer of the cold container 40. An air room 42 is formed at the outer periphery of the cold room 41, that is, the air room 42 surrounds the entire of the cold room 41. A thermal insulating part 43 is formed at the outer periphery of the air room 42. The multiple-layer configuration of the cold container 40 can prevent the invasion of thermal energy from the outside into the cold room 41. An air introduction line 44 and an air exhaust line 45 are joined to the air room 42. Air is introduced into the air room 42 through the air introduction line 44, and the air is exhausted from the air room 42 through the air exhaust line 45. The air introduction line 44 is joined to the low temperature air supply line 28 shown in FIG. 1. The air exhausted from the second storage container 12 (see FIG. 1) is introduced into the air room 42 through the air introduction line 44.

As shown in FIG. 3, an air exhausting valve 46 is mounted on the air exhaust line 45. The air exhausting valve 46 is usually closed. The air exhausting valve 46 becomes open when the inner pressure of the air room 42 in the cold container 40 exceeds a specified value that is determined in advance in order to suppress the increase of the inner pressure of the air room 42. A temperature sensor 47 is placed in the cold room 41 so as to detect the temperature of the cold room 41. The ECU 32 (see FIG. 1) receives a temperature signal transferred from the temperature sensor 47. When receiving the temperature signal transferred from the temperature sensor 47, the ECU 32 controls the operation of both the air supply pump 29 (see FIG. 1) and the air supply adjusting valve 30 (see FIG. 3) so as to supply the liquid air from the second storage container 12 in order to maintain the temperature of the cold room 41 at a constant temperature level. In a concrete example, the ECU 32 opens the air supply adjusting valve 30 and operates the air supply pump 29.

As described above, according to the second embodiment of the present invention, although the main purpose of the liquid air is to cool the liquid hydrogen 11a in the first storage container 11, it is possible to perform the better use of the liquid air contained in the second storage container 12 for cooling the cold container 40 so as to prevent the invasion of thermal energy form the outside thereof.

### (Other Modifications)

Although the first and second embodiments describe the above use the liquid hydrogen as liquid fuel, in the present invention is not limited to just this, for example, it is possible to use various fuels whose boiling point is lower than that of air.

Further, in the first embodiment, the low temperature air vaporized from the liquid air is supplied directly to the inside of the compartment of the electric motorcar. The present invention is not limited by this configuration, for example, it is possible to mix the vaporized air with air supplied from the air conditioning apparatus (not shown) in the refrigerating (or refrigeration) cycle and to supply the mixed air to the inside of the compartment. On the other hand, it is also acceptable to use the vaporized air for cooling various component devices forming the air conditioning apparatus.

When mixing vaporized air with air of the air conditioning apparatus in the refrigerating cycle, a ratio of air conditioning load between the vaporized low temperature air and the air conditioning air is calculated, and the supply amount of the liquid air from the second storage container 12 is determined based on the calculated load ratio.

Further, although the first embodiment explains the application of the liquid air stored in the second storage container 12 to the air conditioning of the compartment of the electric motorcar and the second embodiment has explained the application of the liquid air to the cooling of the cold container 40, the concept of the present invention is not limited by those applications, for example, the concept of the present invention can be applied to various applications which use the refrigeration energy.

Still further, in the first embodiment, although the air supply adjusting valve 30 is opened and the air supply pump 29 operates when the vaporized air is supplied through the low temperature air supply line 28 to the compartment of the electric motorcar, it is possible to eliminate the air supply pump 29 from the liquid fuel storage system 1. In this case, the low temperature air is automatically fed to the inside of the compartment of the electric motorcar under a pressure generated in vaporization of the liquid air when the air supply adjusting valve 30 is opened.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A liquid fuel storage system comprising:
a first storage container configured to store a liquid fuel;
a heat exchanger configured to perform heat exchange between air and liquid fuel or fuel gas vaporized from the liquid fuel and air;
a second storage container, surrounding an outer periphery of the first storage container, configured to store liquid air obtained by the heat exchange performed by the heat exchanger; and
a low temperature air supply line through which the air is fed from the second storage container and supplied to an outside of the liquid fuel storage system for use.

2. The liquid fuel storage system according to claim 1, wherein the low temperature air supply line is joined to an air conditioning apparatus mounted on a vehicle, the air is supplied to the air conditioning apparatus through the low temperature air supply line, and the air conditioning apparatus performs air conditioning of a compartment of the vehicle using the supplied air.

3. The liquid fuel storage system according to claim 1, further comprising:
an air supply adjusting valve configured to open and close the low temperature air supply line; and
control means configured to control operation of the air supply adjusting valve.

4. The liquid fuel storage system according to claim 3, further comprising liquid air storage amount detecting means configured to detect an amount of the liquid air stored in the second storage container,
wherein the control means opens the air supply open/close valve when an judging result thereof indicates that the amount of the liquid air stored in the second storage container is an adequate amount for preventing vaporization of the liquid fuel stored in the first storage container, and
the control means closes the air supply open/close valve when the judging result thereof indicates that the amount of the liquid air stored in the second storage container does not reach the adequate amount to prevent vaporization of the liquid fuel stored in the first storage container.

5. The liquid fuel storage system according to claim 3, further comprising an air supply pump configured to supply the liquid air exhausted from the second storage container to the low temperature air supply line,
wherein the control means operates the air supply pump and opens the air supply adjusting valve simultaneously.

6. The liquid fuel storage system according to claim 4, further comprising an air supply pump configured to supply the liquid air exhausted from the second storage container to the low temperature air supply line,
wherein the control means operates the air supply pump and opens the air supply adjusting valve simultaneously.

7. The liquid fuel storage system according to claim 4, wherein the liquid air storage amount detecting means is a liquid surface level sensor configured to detect a surface level of the liquid air stored in the second storage container.

8. The liquid fuel storage system according to claim 5, wherein the liquid air storage amount detecting means is a liquid surface level sensor configured to detect a surface level of the liquid air stored in the second storage container.

9. The liquid fuel storage system according to claim 1, wherein it is so constructed that the air supplied from the second storage container through the low temperature air supply line is directly introduced into a compartment of a vehicle on which the liquid fuel storage system is mounted.

10. The liquid fuel storage system according to claim 2, wherein it is so constructed that the air supplied from the second storage container through the low temperature air supply line is directly introduced into the compartment of the vehicle on which the liquid fuel storage system is mounted.

11. The liquid fuel storage system according to claim 1, wherein the control means controls the supply amount of the liquid air from the second storage container according to magnitude of a requested load for the air conditioning of a compartment of a vehicle.

12. The liquid fuel storage system according to claim 2, wherein the control means controls the supply amount of the liquid air from the second storage container according to magnitude of a requested load of the air conditioning for a compartment of a vehicle.

13. The liquid fuel storage system according to claim 1, wherein the liquid fuel is liquid hydrogen as a fuel of a fuel cell stack mounted on a vehicle as driving power source.

14. The liquid fuel storage system according to claim 1, wherein it is so constructed that the air fed to the outside from the second storage container through the low temperature air supply line is supplied into a cold container having a cold room in order to cool contents placed in the cold room and the cold container is mounted on an electric motorcar on which the liquid fuel storage system is mounted.

15. The liquid fuel storage system according to claim 14, wherein the cold container is equipped with a temperature sensor configured to detect an inside temperature of the cold room, and
the control means controls the supply amount of the liquid air from the second storage container through the low temperature air supply line based on the inside temperature of the cold room in the cold container detected by the temperature sensor.

16. The liquid fuel storage system according to claim 14, wherein the liquid fuel is liquid hydrogen as a fuel of a fuel cell stack mounted on a vehicle as driving power source.

17. The liquid fuel storage system according to claim 14, further comprising:
an air supply adjusting valve configured to open and close the low temperature air supply line; and
control means configured to control operation of the air supply adjusting valve.

18. The liquid fuel storage system according to claim 17, further comprising liquid air storage amount detecting means configured to detect an amount of the liquid air stored in the second storage container,
wherein the control means opens the air supply open/close valve when an judging result thereof indicates that the amount of the liquid air stored in the second storage container is an adequate amount for preventing vaporization of the liquid fuel stored in the first storage container, and
the control means closes the air supply open/close valve when the judging result thereof indicates that the amount of the liquid air stored in the second storage container does not reach the adequate amount to prevent vaporization of the liquid fuel stored in the first storage container.

19. The liquid fuel storage system according to claim 17, further comprising an air supply pump configured to supply the liquid air exhausted from the second storage container to the low temperature air supply line,
wherein the control means operates the air supply pump and opens the air supply adjusting valve simultaneously.

20. The liquid fuel storage system according to claim 18, wherein the liquid air storage amount detecting means is a liquid surface level sensor configured to detect a surface level of the liquid air stored in the second storage container.
